(19) United States
(12) Patent Application Publication
(10) Pub. No.: US 2018/0071849 A1
(43) Pub. Date: Mar. 15, 2018

(54) METHOD AND DEVICE FOR PRODUCING A HOLLOW BODY

(71) Applicant: fashion.de GmbH, Pforzheim (DE)

(72) Inventor: Roger CERMAK, Neuenbuerg (DE)

(73) Assignee: fashion.de GmbH, Pforzheim (DE)

(21) Appl. No.: 15/559,178

(22) PCT Filed: Mar. 16, 2016
(86) PCT No.: PCT/EP2016/055672

§ 371 Date: Sep. 18, 2017

(30) Foreign Application Priority Data
Mar. 19, 2015 (DE) 10 2015 204 977.9

(51) Int. Cl. B23K 9/04; B23C 3/16; B23C 1/12

(52) U.S. Cl. CPC B23K 9/042; B23C 1/12; B23C 3/16

(57) ABSTRACT

In a method for producing a hollow body, a hollow body wall is created, which delimits a hollow space and which has a hollow space side facing the hollow space and an outer side facing away from the hollow space. The hollow body wall is created in portions by constructing wall segments that are adjacent to one another. Following the construction of a wall segment, the constructed wall segment is processed on the hollow space side before a further wall segment is constructed adjacent to the constructed wall segment. A device for carrying out this method comprises a processing device, by means of which a wall segment constructed by a constructing device is processed on the hollow space side before a further wall segment can be constructed adjacent to the constructed wall segment by the constructing device.

The invention relates to a method for producing a hollow body, within the scope of which method a hollow body wall is created, which delimits a hollow space of the hollow body and which has a hollow space side facing the hollow space and an outer side facing away from the hollow space, wherein the hollow body wall is created in portions by constructing wall segments that are adjacent to one another.

The invention also relates to a device for carrying out the above-mentioned method.

Currently, different methods and devices are customary for the production of hollow bodies.

By way of example, hollow bodies are milled from solid material. Here, a hollow space is made in a hollow body blank by means of a milling tool. In particular, hollow bodies made of metallic materials and satisfying the requirement of having high stability are produced by milling from solid material. One field of application of milling from solid material is medical engineering.

Further known methods for producing hollow bodies are additive manufacturing methods, for example generic selective laser melting (SLM for short). In the case of selective laser melting, material for the hollow body that is to be produced or for the hollow body wall that is to be produced is applied in an assembly space in powder form to a base plate in a thin layer. The powdery material is melted by means of a laser beam in the region that is to form the hollow body wall, and is fused. The powdery material, in the surroundings of the melted and fused material, supports the generated layer of the hollow body wall. Once the material layer has hardened, the base plate is lowered by the amount of a layer thickness, and further material powder is applied to the wall layer now present and is processed in the above-mentioned way.

The described sequences are repeated until the hollow body or the hollow body wall has been completely constructed.

In the case of the generic prior art, the hollow space side of the hollow body wall is processed once the hollow body wall has been completed and is consequently possible only when the finished hollow body or the finished hollow body wall has a geometry on account of which the hollow space side of the hollow body wall is accessible for a processing operation.

The object of the present invention is to develop the known method and the known device so that a hollow body wall processed on the hollow space side can be provided independently of the geometry of the hollow body wall or the hollow body.

In accordance with the invention, this object is achieved by the method according to claim 1 and by the device according to claim 12.

In the case of the invention, the hollow body wall is not only constructed in portions, but also processed in portions on the hollow space side. The processing of the hollow space side of the hollow body wall progresses, accordingly, with the construction of the hollow body wall. Even if the finished hollow body wall has a geometry on account of which the hollow space side thereof is inaccessible for processing, the hollow body wall can be processed on the hollow space side, as long as the hollow body wall is in the process of being constructed. Regardless of the geometry of the hollow body wall, a hollow body wall that is processed at least to the greatest possible extent on the hollow space side is provided at the end of the manufacturing process.

The device for carrying out the manufacturing method according to the invention comprises a device for constructing the wall segments of the hollow body wall adjacent to one another and a device for processing the hollow body wall in portions. Both devices can be of conventional design. By way of example, a conventional processing centre can be provided as processing device. Both the construction and processing of the hollow body wall are performed preferably in a numerically controlled manner.

The fields of application and use of the method according to the invention and of the device according to the invention are diverse. Hollow bodies of which the hollow body wall requires a processing on the hollow space side are found for example on pieces of jewellery and on medical products.

Particular variants of the method according to independent claim 1 and of the device according to independent claim 12 will become clear from dependent claims 1 to 11 and 13 respectively.

In accordance with the invention, the hollow body wall can be processed on the hollow space side in different ways (claim 2). By way of example, the removal of material of a previously constructed wall segment by machining or other processing, for example by drilling, milling, grinding or eroding, is conceivable. It is additionally possible to apply a covering to the hollow space side of a wall segment of the hollow body wall, for example to coat the hollow body wall for protection against corrosion and/or wear. Lastly, processing processes within the scope of which the material properties of the material of the concerned wall segment of the hollow body wall are changed can also be considered, for example processing processes such as hardening, quenching and tempering, annealing, or chemical treatment of the hollow body wall.

The removal and/or application of material to the hollow space side of a wall segment of the hollow body wall can also serve to integrate foreign bodies in the hollow body. Cavities for completely or partially receiving foreign bodies can thus be produced for example by material removal on the inner side of a wall segment of the hollow body wall. Among other things, decorative objects such as precious stones or functional objects such as sensors for detecting the state of the surroundings of the hollow body can be considered as foreign bodies. By applying material, foreign bodies of this type can be fixed movably or immovably in the cavity/cavities receiving them and/or can be embedded partially or completely in the material of the hollow body wall or in the applied material. The purpose of complete embedding can be, for example, a gas-tight and/or radiation-tight accommodation of the foreign bodies in question. It is conceivable that the introduction of foreign bodies is followed by in particular mechanical processing of the wall segment in question in the immediate vicinity of the foreign body.

The device according to the invention has a corresponding functionality.

The variant of the method according to the invention described in claim 3 enables the creation of a hollow body wall with relatively low material use. A low material use is important in particular in cases in which costly materials, for example precious metals, are worked.

The one or more wall segments is/are constructed from a material that is plastic for working, which material, on account of its consistency, makes it possible to dispense with support of the hollow body being created, during the construction of the wall segments. In particular, in contrast with selective laser melting for example, it is not necessary to support the wall segments of the hollow body wall during the construction process by powdery material. Consequently, the outlay associated with the provision of supporting material is spared. Material losses, as can occur in the case of selective laser melting when removing supporting material from the finished hollow body, are avoided.

In accordance with the invention, it is possible to provide the material that is to be worked firstly in solid form and to plasticise it immediately prior to being worked. Here, a plasticisation by heating is preferred. A device according to the invention for carrying out a variant of this type of the method according to the invention is described in claim 13.

Instead of powdery materials, wires made of the material in question can be used for example, which are plasticised by addition of heat prior to being worked. Material wires of this type in particular enable a layered construction of the wall segments of the hollow body wall. With use of material wires, the generally high outlay for the production of a material powder is spared. In addition, material wires are generally characterised by good workability, whereas the workability of material powder can be limited for example on account of non-uniform particle size. Lastly, the use of material wires allows the processing of materials that are not available in powder form.

As soon as the plasticised material of a constructed wall segment has cured, the wall segment is processed on the hollow space side, before a further wall segment is constructed adjacently to the constructed wall segment. In a preferred embodiment of the invention, the further wall segment is also constructed from a material that is plastic in a state for being worked and that then cures following the state for being worked.

For the reasons presented, the method according to the invention is advantageous in particular in applications in which a hollow body wall, which surrounds the hollow space at least approximately completely, is created in portions by constructing wall segments that are adjacent to one another (claim 4). If the hollow body wall surrounds the hollow space of the hollow body completely, the hollow body wall can be processed on the hollow space side until the wall segment ultimately closing the hollow space is constructed. Only the hollow space side of this last wall segment is not accessible for processing.

In a further advantageous embodiment of the invention, the method according to the invention serves to create a hollow body wall that has a curvature on the hollow space side and/or on the outer side (claim 5).

According to claim 6, in a further preferred embodiment of the method according to the invention, a wall segment is constructed in layers from a plurality of material layers arranged one above the other and/or side by side.

Once a wall segment has been constructed in layers, it can be processed over its entire area on the hollow space side. In accordance with the invention and according to claim 7, the hollow space side of the wall segment constructed in layers is preferably processed with the exception of the last material layer created during the construction process. The last material layer created during the construction of a wall segment serves in this case in the unprocessed state as a basis for the wall segment adjacent to the constructed wall segment. In cases in which material is removed during the processing of a constructed wall segment, for example, the use of the material layer, created last in the construction of the wall segment, in the unprocessed state ensures that a base of sufficiently large area is available for the next wall segment.

This circumstance is advantageous in particular if a hollow body wall is created using the method according to the invention, which hollow body wall has a curvature on the hollow space side and/or on the outer side (claim 5). In order to produce a curvature of the finished hollow body wall, during the creation of said hollow body wall a further wall segment adjacent to a constructed wall segment is constructed with an offset relative to the wall segment already constructed. Following the construction of the wall segments adjacent to one another with a mutual offset, a transition corresponding to the desired curvature is created between said wall segments by removing material from said wall segments. If the last material layer of the wall segment first constructed was already processed before construction of the adjacent wall segment, i.e. if material was thus be removed at the last material layer of the wall segment constructed first, before construction of the next wall segment is started, the last material layer of the wall segment constructed first would thus provide a base of only relatively small area for the next wall segment.

In order to minimise the material use when creating a curved hollow body wall with at least one wall segment constructed in layers, the wall segment in question, in accordance with claim 8, is constructed from material layers that follow on from one another along the curvature and that are offset from one another so as to form the curvature. A curvature can be produced in this way already when constructing the wall segment. It is therefore not necessary to construct a wall segment with a thickness that is dimensioned such that, after the construction of the wall segment, the desired curvature can be produced merely by removing material from the constructed wall segment.

In particular when constructing a wall segment in layers, there are the options to construct a wall segment from a single material (claim 9) or to use different materials for the same wall segment. If different materials are used, it is readily possible for example to provide a change of material, colour and quality by means of a corresponding material choice. Use is made of this option inter alia in the production of pieces of jewellery.

Accordingly, within the scope of the method according to the invention, wall segments can be constructed that are made of the same material(s) (claim 10) or that are made of different materials.

A material change is conceivable between different layers or within the same layer, but also between different layers and at the same time within one or more layers. By means of a corresponding design of the material change, different patterns for example, such as what is known as a zebra design, can be produced in the hollow body wall. In the case of pieces of jewellery, a change of white gold and yellow gold lends itself, for example.

In addition to a processing of a constructed wall segment on the hollow space side thereof, it is provided in a development of the invention that, after the construction of a wall segment, this wall segment is also processed on the outer side (claim 11). The processing of the wall segment on the outer side can be performed before a further wall segment is constructed adjacently to the wall segment already constructed. However, a processing of the outer side of the hollow body wall once a plurality of wall segments of the hollow body wall adjacent to one another or once all wall segments of the hollow body wall have been created is also conceivable. In accordance with the invention, processing methods that make it possible to dispense with a finishing of the outer side of the hollow body wall, for example a polishing of the hollow body on the outer side thereof, are preferred.

The invention will be explained in greater detail on the basis of exemplary schematic illustrations, in which:

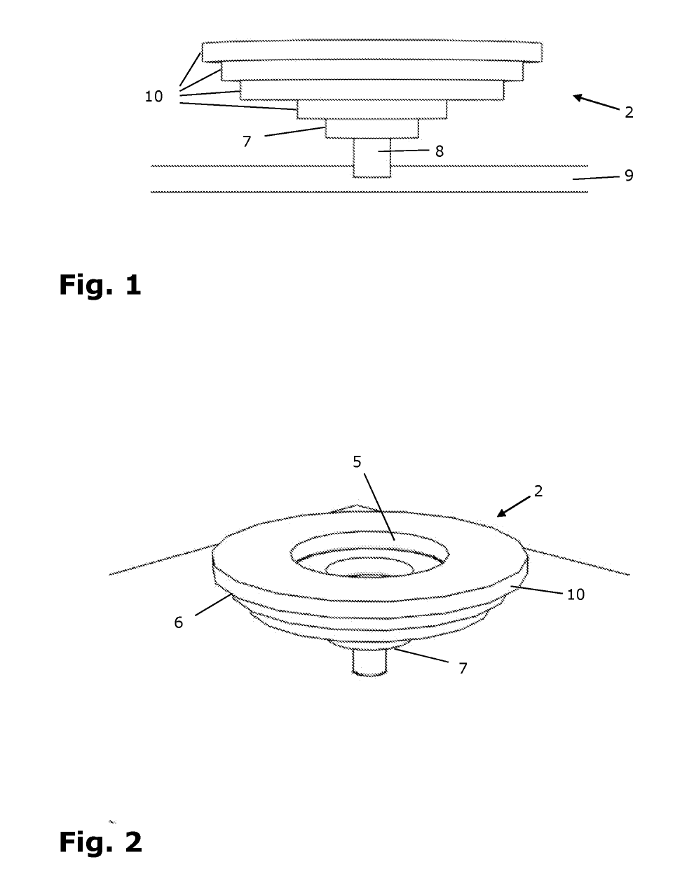

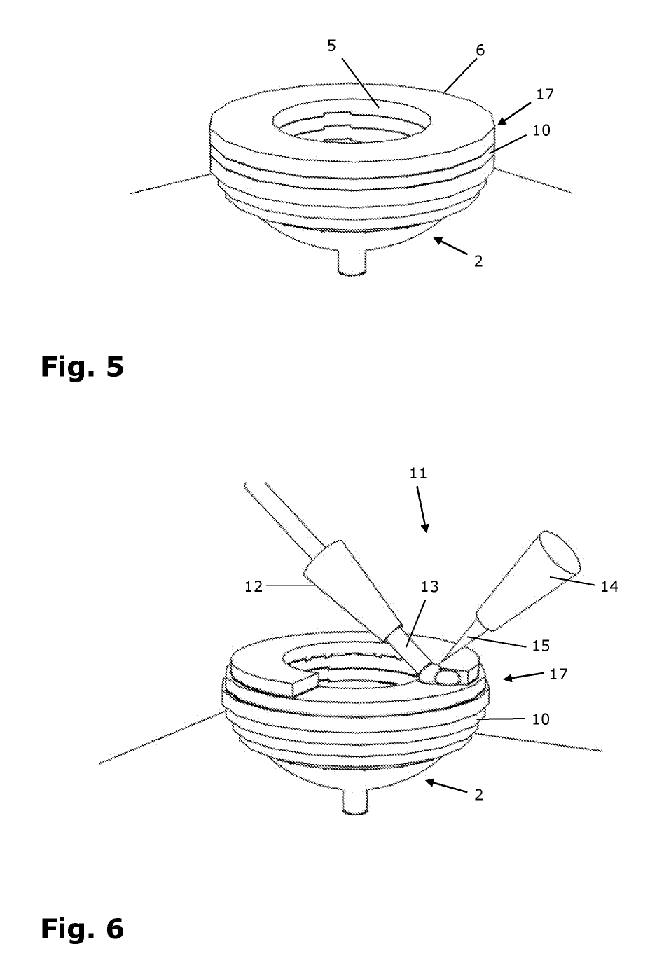

FIGS. 1 to 9 show the production of a hollow body in the form of a sphere by means of a device provided for this purpose.

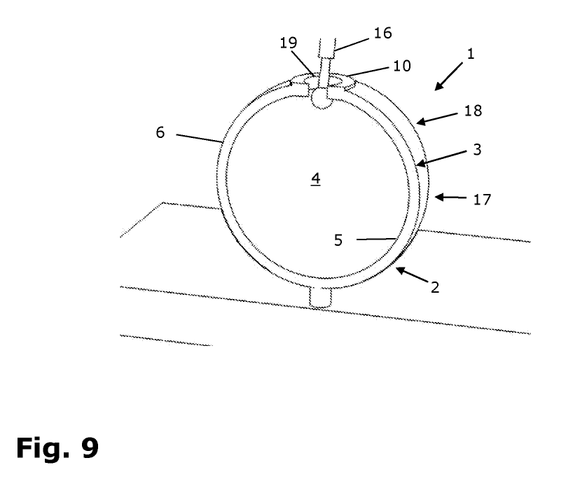

According to FIGS. 1 and 2, a first wall segment 2 of a sphere shell 3 provided as a hollow body wall is constructed in a first phase of the production of a hollow body formed as a sphere 1 and shown in FIG. 8 and in the sectional illustration of FIG. 9 immediately before completion. The sphere shell 3 delimits a hollow space 4 of the sphere 1 and has a hollow space side 5 facing the hollow space 4 and an outer side 6 facing away from the hollow space 4 (FIG. 9).

In order to construct the wall segment 2, a disc-like lower material layer 7 of the material of the sphere shell 3 is applied to a pin-like spacer 8. By means of the spacer 8, the lower material layer 7 of the wall segment 2 is held at a distance from a base plate 9. A plurality of sphere shells 3 can be arranged side by side on the base plate 9 in the illustrated manner.

A plurality of annular material layers 10 of material of the sphere shell 3 are applied in succession to the disc-like lower material layer 7 of the wall segment 2.

For this purpose, a constructing device 11 is used, which is illustrated inter alia in FIG. 4.

The constructing device 11 comprises, as feed device, a material feeder 12, which is attached to a robot arm (not shown) of the constructing device 11. By means of the material feeder 12, the material of the sphere shell 3 is fed as material wire 13 to the working point. The material feeder 12 corresponds in terms of its construction and operating principle to known devices for feeding welding wire in gas shielded metal arc welding.

At the working point, the material wire 13 fed by the material feeder 12 is plasticised by addition of heat by means of a laser head 14 serving as heating device and a laser beam 15 directed from the laser head 14 to the working point. The laser head 14 is also mounted on a robot arm (not shown) of the constructing device 11. In a numerically controlled manner, the robot arm with the material feeder 12 and the robot arm with the laser head 14 travel over the circular path along which the annular material layers 10 of the wall segment 2 are to be constructed from the plasticised material of the material wire 13.

In order to form the curvature of the sphere shell 3, the annular material layers 10 of the wall segment 2 are offset in the radial direction of the sphere shell 3 relative to the disc-like lower material layer 7 and also relative to one another. This results in a stepped course of the wall segment 2 of the sphere shell 3 both on the hollow space side 5 and on the outer side 6, as can be seen from FIGS. 1 and 2.

Once the plasticised material has cured, the wall segment 2 constructed from the lower material layer 7 and the further material layers 10 is processed firstly on its outer side.

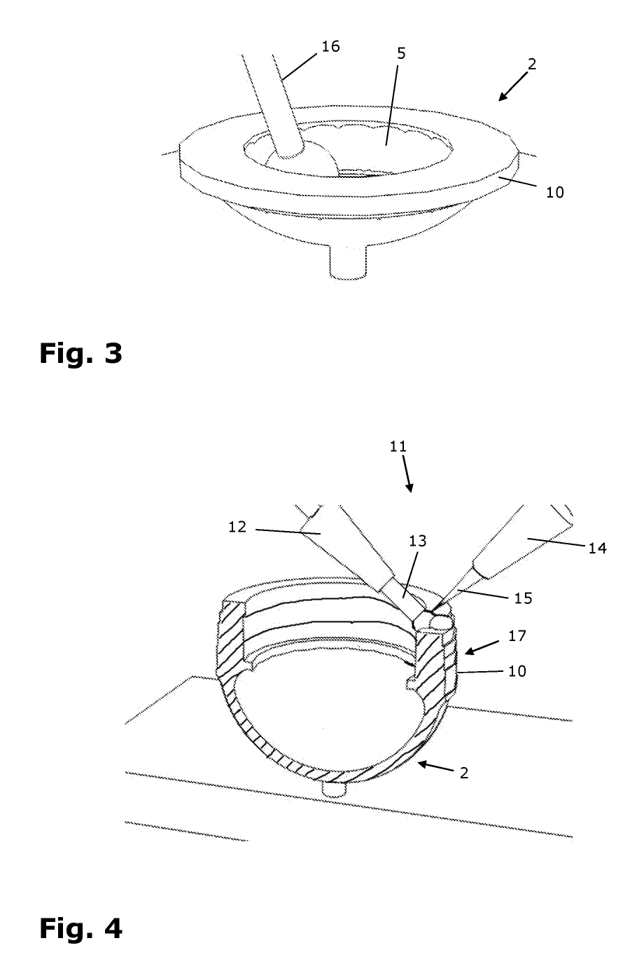

A milling tool 16 of conventional design, which is attached to a robot arm (not shown) and which is guided along the outer side of the wall segment 2 with a numerically controlled movement and in so doing produces a smooth spherical shape from the step shape on the outer side of the wall segment 2, is schematically illustrated as processing tool in FIG. 3. Accordingly, the wall segment 2 is processed on the hollow space side 5 as per FIG. 3. The sphere shell segment formed by the wall segment 2 after the processing on the hollow space side 5 and on the outer side 6 can be seen in the lower part of FIG. 4.

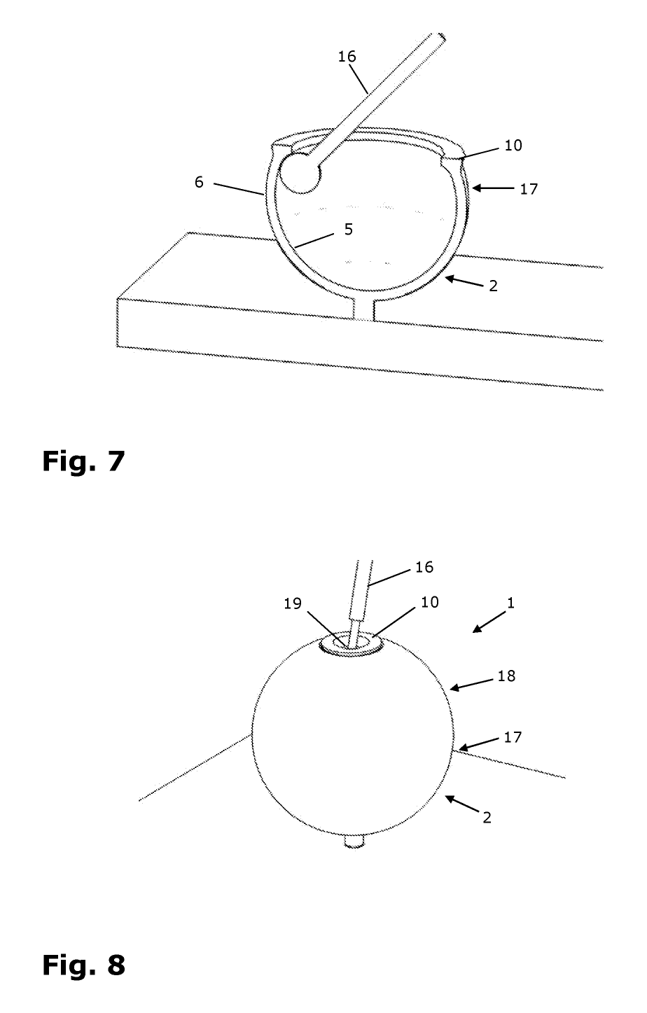

Both on the hollow space side 5 and on the outer side 6, the material layer 10 applied last when constructing the wall segment 2 is omitted when processing the wall segment 2. On the last material layer 10 of the wall segment 2, after processing thereof, a further wall segment 17 of the sphere shell 3 is constructed adjacently to the previously constructed wall segment 2. Here, further material layers 10 of material of the sphere shell 3 are applied in the manner described above and illustrated in FIGS. 4 to 6. The wall segment 17 is also processed by means of the milling tool 16 on the outer side and on the hollow space side 5 after the solidification of the material that has been plasticised for being worked (FIG. 7). When processing the wall segment 17, the material layer 10 last applied is also omitted.

A further wall segment 18 is constructed on the last material layer 10 of the wall segment 17, adjacently to the previously constructed wall segment 17. Following the construction of the wall segment 18 and the subsequent curing of the material used to construct the wall segment 18, the wall segment 18 is also processed in the above-described manner by means of the milling tool 16 on the outer side 6 and on the hollow space side 5 (FIGS. 8 and 9). Also on the wall segment 18, the material layer 10 last applied is omitted from the processing.

The sphere shell 3 of the sphere 1 is then completed, apart from a shell opening 19. The shell opening 19 is required so as to be able to introduce the milling tool 16 for processing the hollow space side 5 of the wall segment 18 into the hollow space 4. Due to the spatially confined conditions, a milling tool 16 of small design is used in this case.

Once the processing of the wall segment 18 is complete, the milling tool 16 is removed from the hollow space 4 of the sphere shell 3 and the shell opening 19 is closed by means of the manufacturing device 11. Alternatively, in order to close the shell opening 19, it is possible to apply a disc-like upper material layer of material of the sphere shell 3 corresponding to the disc-like lower material layer 7 of the wall segment 2 to the material layer 10 created last when constructing the wall segment 18.

The closure of the shell opening 19 is provided on the outer side 6 with the desired smooth sphere surface by means of the milling tool 16. Lastly, the sphere shell 3 is separated from the spacer 8 and, if necessary, is processed at the point of attachment of the spacer 8 in order to produce a smooth sphere surface.

1. A method for producing a hollow body (1), within the scope of which method a hollow body wall (3) is created, which delimits a hollow space (4) of the hollow body (1) and which has a hollow space side (5) facing the hollow space (4) and an outer side (6) facing away from the hollow space (4), the hollow body wall (3) being created in portions by constructing wall segments (2, 17, 18) that are adjacent to one another, wherein, following the construction of a wall segment (2, 17, 18), the constructed wall segment (2, 17, 18) is processed on the hollow space side (5), before a further wall segment (17, 18) is constructed adjacently to the constructed wall segment (2, 17, 18).

2. The method according to claim 1, wherein, following the construction of a wall segment (2, 17, 18), the constructed wall segment (2, 17, 18) is processed on the hollow space side (5) by removing material of the constructed wall segment (2, 17, 18) and/or by producing a covering and/or by changing material properties of the material of the constructed wall segment (2, 17, 18).

3. The method according to claim 1, wherein a wall segment (2, 17, 18) is constructed from a material that is plastic in a state for being worked and which cures following the state for being worked, by the wall segment (2, 17, 18) being constructed from the material in the state for being worked, and in that the constructed wall segment (2, 17, 18) is processed on the hollow space side (5) once the material has cured, before a further wall segment (17, 18) is constructed adjacently to the constructed wall segment (2, 17, 18).

4. The method according to claim 1, wherein a hollow body wall (3), which at least approximately completely surrounds the hollow space (4), is created in portions by constructing wall segments (2, 17, 18) that are adjacent to one another.

5. The method according to claim 1, wherein a hollow body wall (3), which has a curvature on the hollow space side (5) and/or on the outer side (6), is created in portions by constructing wall segments (2, 17, 18) that are adjacent to one another.

6. The method according to claim 1, wherein a wall segment (2, 17, 18) is constructed in layers from a plurality of material layers (7, 10) arranged one above the other and/or side by side.

7. The method according to claim 6, wherein the wall segment (2, 17, 18), after having been constructed in layers, is processed on the hollow space side (5) with the exception of the material layer (10 last constructed, before a further wall segment (17, 18) is constructed adjacently to the constructed wall segment (2, 17, 18).

8. The method according to claim 5, wherein a wall segment (2, 17, 18) is constructed in layers from material layers (7, 10) following on from one another along the curvature, the material layers (7, 10) being offset relative to one another so as to form the curvature.

9. The method according to claim 1, wherein at least one wall segment (2, 17, 18) is constructed that is made of a single material.

10. The method according to claim 1, wherein at least two wall segments (2, 17, 18) are constructed which are made of the same material(s).

11. The method according to claim 1, wherein, once a wall segment (2, 17, 18) has been constructed, this wall segment is processed on the outer side (6).

12. A device for producing a hollow body (1) with a hollow space (4) and a hollow body wall (3) delimiting the hollow space (4), which hollow body wall has a hollow space side (5) facing the hollow space (4) and an outer side (6) facing away from the hollow space (4), said device having a constructing device (11), by means of which the hollow body wall (3) can be created in portions by constructing wall segments (2, 17, 18) that are adjacent to one another, comprising a processing device (16), by means of which a wall segment (2, 17, 18) constructed by means of the constructing device (11) can be processed on the hollow space side (5) before a further wall segment (17, 18) can be constructed adjacently to the constructed wall segment (2, 17, 18) by means of the constructing device (11).

13. The device according to claim 12, wherein the constructing device (11) comprises a feed device (12) and a heating device (14), it being possible to feed material for a wall segment (2, 17, 18) in the solid state by means of the feed device (12), and to plasticise, by means of the heating device (14), the solid material for the wall segment (2, 17, 18) fed by means of the feed device (12) , and to construct the wall segment (2, 17, 18) from the material plasticised by means of the heating device (14).
